(19) United States
(12) Patent Application Publication
(10) Pub. No.: US 2012/0321125 A1
(43) Pub. Date: Dec. 20, 2012

(54) IMAGE PROCESSING METHOD AND APPARATUS

(75) Inventors: Yoon Hee CHOI, Suwon-si (KR); Hee Seon Park, Seoul (KR)

(73) Assignee: Samsung Electronics Co., Ltd., Suwon-si (KR)

(21) Appl. No.: 13/523,319

(22) Filed: Jun. 14, 2012

(30) Foreign Application Priority Data
Jun. 14, 2011 (KR) 10-2011-0057628

(51) Int. Cl. G06K 9/46

(52) U.S. Cl. 382/100

(57) ABSTRACT

An image processing method and apparatus extracts unique identifiers directly from images and examines similarities between images using the extracted identifiers, by capturing a frame of an image; reducing the size of the captured frame; transforming the reduced frame to a frequency domain frame; creating an image feature vector by scanning frequency components of the frequency domain frame; computing inner product values by projecting the image feature vector onto random vectors; generating a fingerprint for identifying the captured frame by applying a Heaviside step function to the inner product values; and searching a database for information related to the generated fingerprint and outputting the search results.

### PRIORITY

This application claims priority under 35 U.S.C. §119(a) to Korean Patent Application No. 10-2011-0057628, which was filed in the Korean Intellectual Property Office on Jun. 14, 2011, the entire disclosure of which is incorporated herein by reference.

### BACKGROUND OF THE INVENTION

1. Field of the Invention

The present invention relates generally to image processing and, more particularly, to an image processing method and apparatus that can extract unique identifiers or fingerprints directly from images and examine similarities between images using the extracted identifiers.

2. Description of the Related Art

With increased usage of multimedia in recent years, there has been a rise in demand for techniques for multimedia data retrieval and recognition. In examining the similarity between multimedia items, comparing multimedia items in binary form may be impractical since even minor image processing operations may significantly change binary values of the multimedia items. Alternatively, various identifiers may be used to compare multimedia items. Such unique identifiers are referred to as fingerprints, also known as signatures or hash, and several video recognition methods based on various types of fingerprints have been implemented.

Audio fingerprints have been used in some video recognition methods. However, this method may be unsuitable to silent portions of a video and may take a relatively long time to identify the exact location in time of the audio fingerprint.

Image fingerprints have been used in video recognition methods as well. In such a method, a frame is captured from a video and a fingerprint is extracted from the captured frame. However, the fingerprint may be ineffective for image matching, where the fingerprint is extracted using color properties of the frame and the color properties of the corresponding frame are changed after image processing. As in existing methods based on image fingerprints, when fingerprints are represented as vectors and the distance between the fingerprint vectors is used for video matching, retrieval efficiency may be lowered in large multidimensional databases.

### SUMMARY OF THE INVENTION

Accordingly, the present invention has been made to solve the above problems occurring in the prior art and the present invention provides an image processing method and apparatus that enable extraction of a fingerprint that is highly resistant to image processing operations and fast retrieval of information matching the fingerprint from a database.

In accordance with an aspect of the present invention, there is provided a method for image processing, including capturing a frame of an image; reducing the size of the captured frame; transforming the reduced frame to a frequency domain frame; creating an image feature vector by scanning frequency components of the frequency domain frame; computing inner product values by projecting the image feature vector onto random vectors; generating a fingerprint for identifying the captured frame by applying a Heaviside step function to the inner product values; and searching a database for information related to the generated fingerprint and outputting the search results.

In accordance with another aspect of the present invention, there is provided an apparatus for image processing, including a frame capturer capturing a frame of an image; a fingerprint extractor extracting a fingerprint from the captured frame; and a fingerprint matcher searching a database for information related to the fingerprint, wherein the fingerprint extractor reduces the size of the captured frame, transforms the reduced frame to a frequency domain frame, creates an image feature vector by scanning frequency components of the frequency domain frame, computes inner product values by projecting the image feature vector onto random vectors, and generates the fingerprint by applying a Heaviside step function to the inner product values.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of an image processing apparatus according to an embodiment of the present invention;

FIG. 2 is a flowchart of an image processing method according to another embodiment of the present invention;

FIG. 3 is a diagram illustrating image processing operations in the method of FIG. 2;

FIG. 4 is a diagram illustrating methods for reducing the image size in the method of FIG. 2;

FIG. 5 is a diagram illustrating the plots of normalized average matching scores with respect to the compression ratio when original images and their JPEG compressed images are compared;

FIG. 6 is a diagram illustrating the plots of normalized average matching scores with respect to the noise variance when original images and their corrupted images with Gaussian noise are compared; and

FIG. 7 is a diagram illustrating a distribution of the bit error rate for the method obtained from applying the JPEG compression and Gaussian noise.

### DETAILED DESCRIPTION OF EMBODIMENTS OF THE PRESENT INVENTION

Hereinafter, various embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments does not address every possible variation of the invention. Therefore, various changes may be made and equivalents may be substituted for elements of the invention.

The image processing apparatus of the present invention is a device having a wired or wireless communication module, and may be any information and communication device such as a personal computer, laptop computer, desktop computer, MP3 player, Portable Multimedia Player (PMP), Personal Digital Assistant (PDA), tablet computer, mobile phone, smart phone, smart TV, Internet Protocol TV (IPTV), set-top box, cloud server, or portal site server. The image processing apparatus may include a fingerprint extractor that extracts a fingerprint from an image received from a database server, smart phone, or IPTV. Here, the fingerprint is an identifier specific to an image and is also known as a signature or hash. The image processing apparatus may retrieve images or supplementary information (such as an Electronic Program Guide (EPG)) related to the extracted fingerprint from an image database server. The image processing apparatus may further include a fingerprint matcher that examines similarity between fingerprints and outputs the result. The image processing apparatus may display retrieval results and similarity examination results or provide them to an external device. In the description, the image processing apparatus is assumed to act as a server that examines similarity between images.

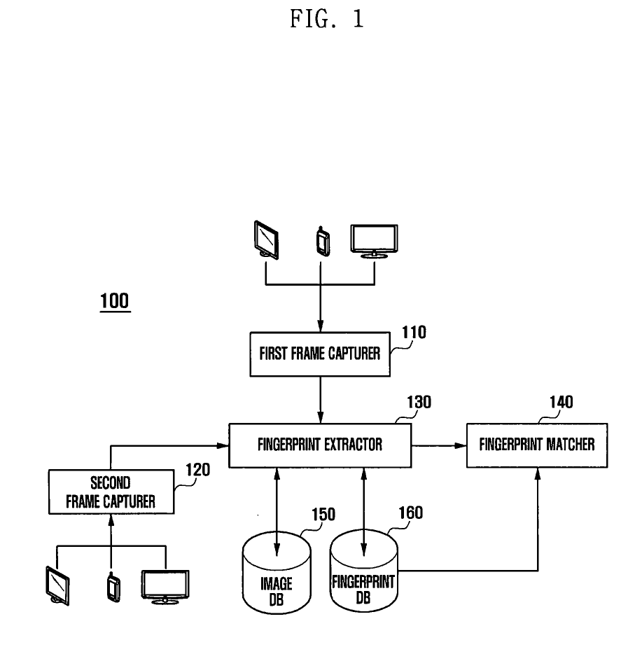

FIG. 1 is a block diagram of an image processing apparatus 100 according to an embodiment of the present invention.

Referring to FIG. 1, the image processing apparatus 100 may include a first frame capturer 110, a second frame capturer 120, a fingerprint extractor 130, a fingerprint matcher 140, an image database 150, and a fingerprint database 160.

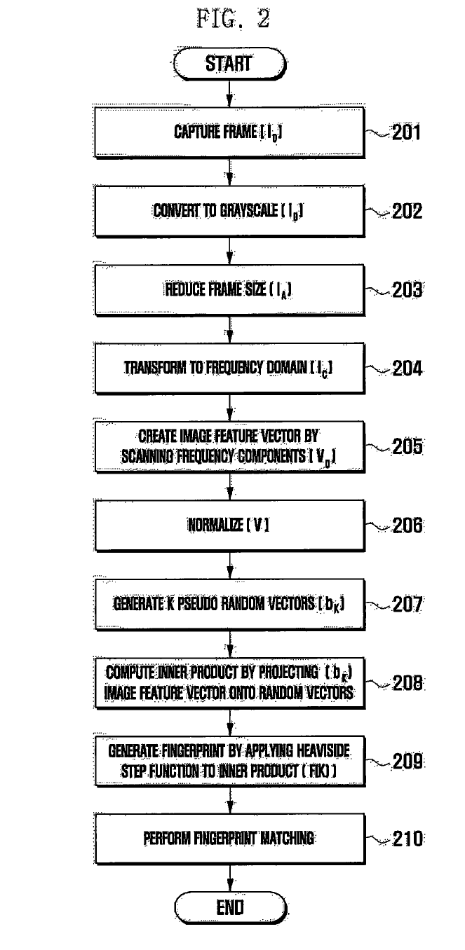

The first frame capturer 110 captures a frame of an image to be recognized, which is output from a digital broadcast receiver, IPTV, smart phone, or laptop computer. The second frame capturer 120 captures a frame of a reference image, which is output from a digital broadcast receiver, IPTV, smart phone, or laptop computer. The fingerprint extractor 130 extracts a fingerprint from the frame captured by the first frame capturer 110 and forwards the extracted fingerprint to the fingerprint matcher 140. The fingerprint extractor 130 extracts a fingerprint from the frame captured by the second frame capturer 120 and stores the extracted fingerprint together with reference image information (for example, film information or broadcast channel information) in the fingerprint database 160. The fingerprint extractor 130 may also extract a fingerprint from an image retrieved from the image database 150 and store the extracted fingerprint in the fingerprint database 160. The fingerprint matcher 140 examines similarity between the fingerprint of an image to be recognized and the fingerprint of a reference image. In other words, the fingerprint matcher 140 searches the fingerprint database 160 for image information related to the fingerprint of an image to be recognized. Next, the present invention is described further with focus on the fingerprint extractor 130 and the fingerprint matcher 140 in connection with FIGS. 2 to 7.

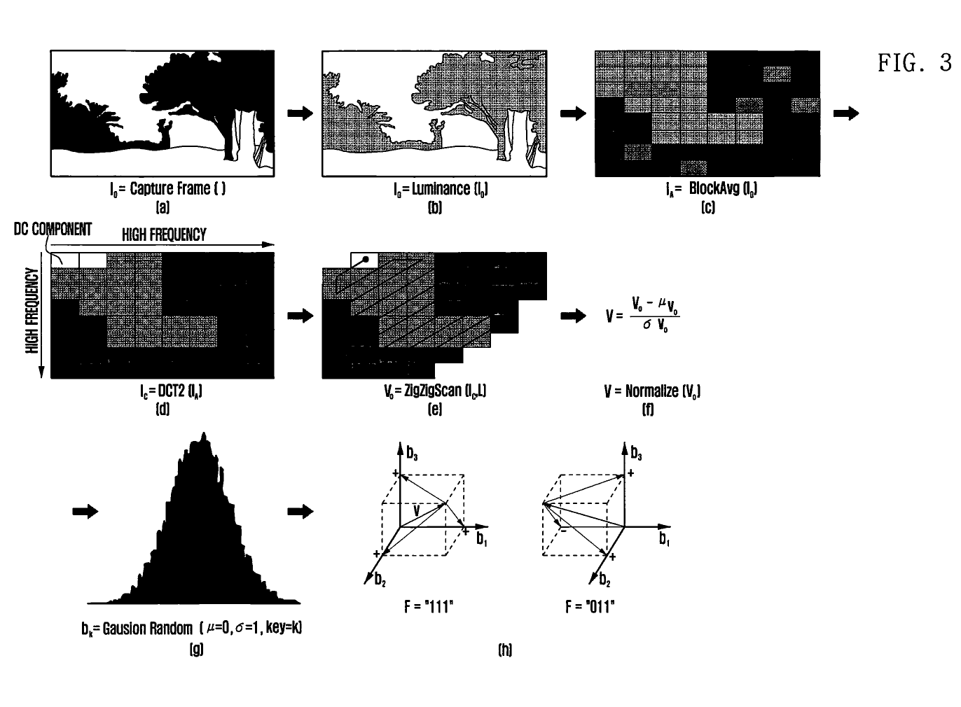

FIG. 2 is a flowchart of an image processing method according to another embodiment of the present invention, and FIG. 3 illustrates image processing operations in the method of FIG. 2.

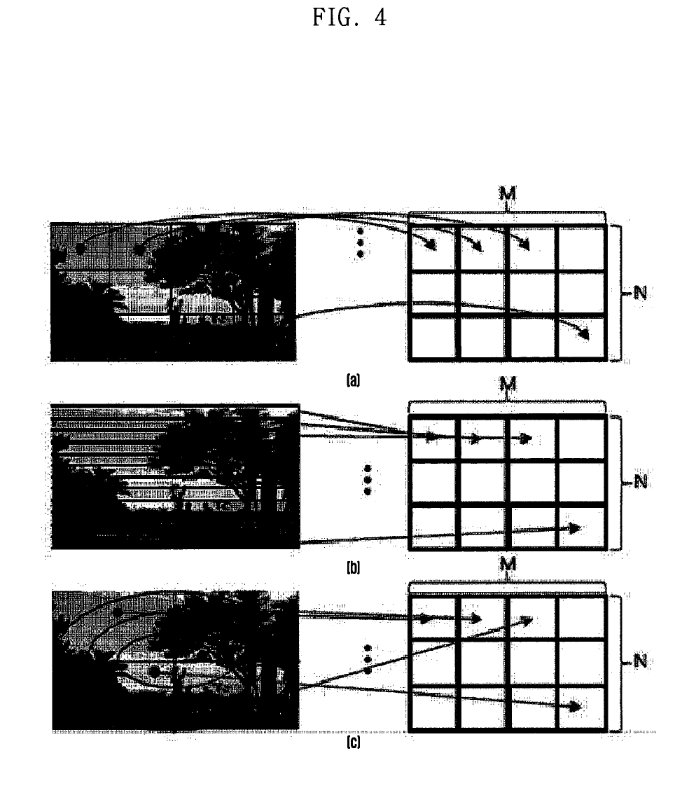

Referring to FIG. 2, the frame capturer 110 or 120 of FIG. 1 captures at least one frame (I_{O}, as indicated by (a) of FIG. 3) from a received image and forwards the captured frame to the fingerprint extractor 130 in step 201. Here, when the received image is interlace-scanned, the frame capturer 110 or 120 may capture an odd field picture and even field picture from the received image and forward the odd and even field pictures to the fingerprint extractor 130, which then may extract one fingerprint from each field picture. The fingerprint extractor 130 converts the captured frame into a grayscale frame (I_{G}, as indicated by (b) of FIG. 3) in step 202, but step 202 may be skipped. The fingerprint extractor 130 reduces the size of the captured frame or grayscale frame into a small average image (I_{A}, as indicated by (c) of FIG. 3) of width M and height N in step 203. Reducing the image size is described in detail with reference to FIG. 4.

FIG. 4 illustrates methods for reducing the image size in the method of FIG. 2.

As illustrated in FIG. 4, the fingerprint extractor 130 subdivides the frame into multiple areas. For example, the frame may be subdivided into rows and columns as indicated by (a) of FIG. 4, be subdivided into rows as indicated by (b) of FIG. 4, or be subdivided into oval shapes as indicated by (c) of FIG. 4. The frame may be subdivided in other ways. Thereafter, the fingerprint extractor 130 selects M*N areas from among the multiple areas. Here, the fingerprint extractor 130 excludes an area in which a caption, logo, advertisement or broadcast channel indicator is to be located in area selection.

Finally, the fingerprint extractor 130 computes average values of the individual selected areas. The average values I_{A}(i,j) can be defined by Equation (1).

$${I}_{A} ( i , j ) = \frac{1}{\vert {P}_{k} \vert} {\sum }_{p ∈ {P}_{k}} {I}_{G} ( p ) , \\ where k = i \times M + j , i = 0 , 1 , … , M \\ and j = 0 , 1 , … , N \qquad Equation ( 1 )$$

Here, |Pₖ| denotes the number of pixels in the k-th area and I_{G}(p) denotes the pixel value at a point p.

Referring back to FIG. 2, the fingerprint extractor 130 transforms the small average image (i.e. reduced frame I_{A}(i,j)) to a frequency domain frame (I_{c}) in step 204. Here, Discrete Cosine Transform (DCT), Discrete Fourier Transform (DFT) or Discrete Wavelet Transform (DWT) may be applied. As DCT is normally used for video coding, usage of two dimensional DCT (2D-DCT) is assumed in the following description.

The fingerprint extractor 130 scans frequency components (coefficients) of the 2D-DCT transformed frame (I_{C}=2DCT(I_{A}), as indicated by (d) of FIG. 3) to create an image feature vector (V_{O}=Scan(I_{c},L)) for the captured frame I_{O} in step 205. Here, L denotes the dimensions of the image feature vector (i.e., the number of frequency components). The fingerprint extractor 130 need not scan all the frequency components in I_{C}. For example, as indicated by (e) of FIG. 3, the Direct Current (DC) component and high-frequency components exceeding a preset threshold value are excluded and only low-frequency components are scanned in a zigzag fashion. This is because the DC component is too sensitive to brightness and high-frequency components exceeding the threshold value may cause signal processing distortion. In other words, low-frequency components not exceeding the threshold value are resistive to various signal processing operations and are not easily distorted. Here, the threshold value may be set by the user. For example, when I_{C} has 8*8 (=64) entries, the fingerprint extractor 130 may scan 48 frequency components excluding the DC component and high-frequency components to create an image feature vector of 48 dimensions (V_{O}=ZigzagScan(I_{c}, L)).

The fingerprint extractor 130 normalizes the image feature vector V_{O}, as indicated by (f) of FIG. 3, so that the mean of V_{O} becomes 0 and the variance thereof becomes 1 in step 206. Here, step 206 may be skipped. Normalization may be performed using Equation (2).

$$V = \frac{{V}_{O} - {μ}_{{V}_{o}}}{{σ}_{{V}_{o}}} \qquad Equation ( 2 )$$

Here μ_{V}_{_{O}} indicates the mean of {V_{O}_{₁}, V_{O}_{₂}, . . . V_{O}_{_{L}}} and σ_{V}_{_{O}} indicates the standard deviation of {V_{O}_{₁}, V_{O}_{₂}, . . . , V_{O}_{_{L}}}.

The fingerprint extractor 130 generates a random vector matrix B having K (for example, 48) random vectors as column vectors in step 207. Here, the K random vectors may follow a Gaussian distribution with mean of 0 and variance of 1 as indicated by (g) of FIG. 3. The k-th random vector may be obtained using Equation (3).

bₖ=Rand(Sₖ, L) Equation (3)

where k=0, 1, . . . , K−1

Here, Sₖ indicates a seed value and L indicates the dimensions of the pseudo random vector.

The fingerprint extractor 130 computes the inner product value of the normalized image feature vector V and the pseudo random vector bₖ by projecting V onto bₖ in step 208. Here, inner product computation is performed once for each random vector, resulting in K inner product values. Projection of the normalized image feature vector V onto random vectors b₁, b₂, b₃ is geometrically illustrated by (h) of FIG. 3.

The fingerprint extractor 130 obtains a fingerprint f for recognizing the captured frame I_{O} by applying a Heaviside step function to the inner product (f=F(k)) in step 209. Steps 208 and 209 may be represented by Equation (4).

f=H(B^{T}V) Equation (4)

where H(B^{T}V) is a Heaviside step function.

Specifically, the Heaviside step function may be defined by Equation (5).

$$H ( x ) = \{ \begin{matrix}1 , & x \geq 0 \\ 0 , & otherwise\end{matrix} \qquad Equation ( 5 )$$

That is, a “Heaviside step function” is a function that produces 0 for negative arguments and produces 1 for non-negative arguments. As the Heaviside step function is applied to K inner product values, the obtained fingerprint f is a K-bit binary value. When the captured frame I_{O} is a frame of a reference image, the fingerprint extractor 130 stores the obtained fingerprint in the fingerprint database 160. When the captured frame I_{O} is a frame of an image to be recognized, the fingerprint extractor 130 forwards the obtained fingerprint to the fingerprint matcher 140.

At step 209, the fingerprint extractor 130 may generate multiple fingerprints for a single frame using Equation (6).

fₛ=H(B_{S}^{T}V), Equation (6)

where s=0, 1, . . . , S−1.

Here, fₛ denotes the s-th fingerprint of the frame.

The fingerprint matcher 140 performs fingerprint matching between fingerprints and outputs the matching results in step 210. The normalized Hamming distance d_{H} is calculated using Equation (7).

$${d}_{H} ( {f}^{q} , {f}^{d} ) = \frac{1}{K} {\sum }_{k} \vert {f}^{q} ( k ) - {f}^{d} ( k ) \vert \qquad Equation ( 7 )$$

Here f^{q} is a fingerprint for an image to be recognized and f^{d} is a fingerprint for an image stored in the database.

After calculation of the Hamming distance between two fingerprints, the fingerprint matcher 140 determines that the two images related respectively to the two fingerprints are different when the Hamming distance is greater than a preset threshold value, and determines that the two images are similar when the Hamming distance is less than or equal to the threshold value. Then, the fingerprint matcher 140 outputs the determination result. For example, assume that f^{q} is 1111001111₍₂₎, f^{d} is 1111001110₍₂₎, and the threshold value is 1. As the Hamming distance between the two fingerprints is 1, the fingerprint matcher 140 determines that the two images related respectively to the two fingerprints are the same. As image matching using the Hamming distance (i.e. Equation (7)) involves multiple bitwise comparisons, the search time may be long when the fingerprint database is large.

The fingerprint matcher 140 may use a generated integer fingerprint as a key together with indexing techniques implemented in existing databases to perform an efficient search. The fingerprint matcher 140 may perform a constant-time search through direct access to the memory using an integer fingerprint. When S fingerprints are extracted from a single image or video frame as described above, the fingerprint matcher 140 may perform image matching for each fingerprint and combine the matching results. For example, the fingerprint matcher 140 may return as a result an image that has been most frequently matched with the S fingerprints. When the threshold value for matching is set to 1 (bit), the fingerprint matcher 140 may newly generate K fingerprints by modifying one bit of a given fingerprint and perform additional matching using the newly generated fingerprints.

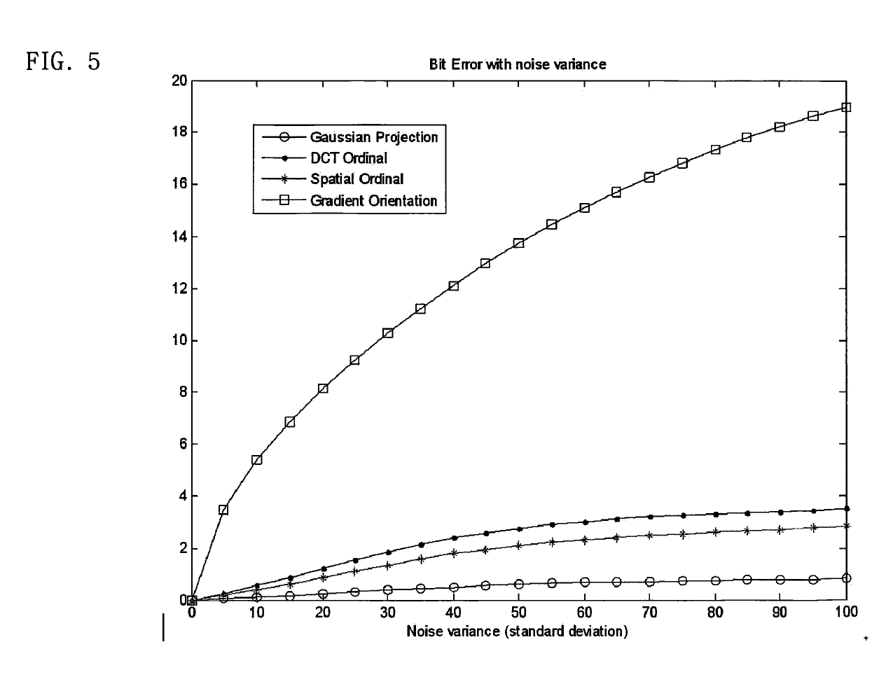

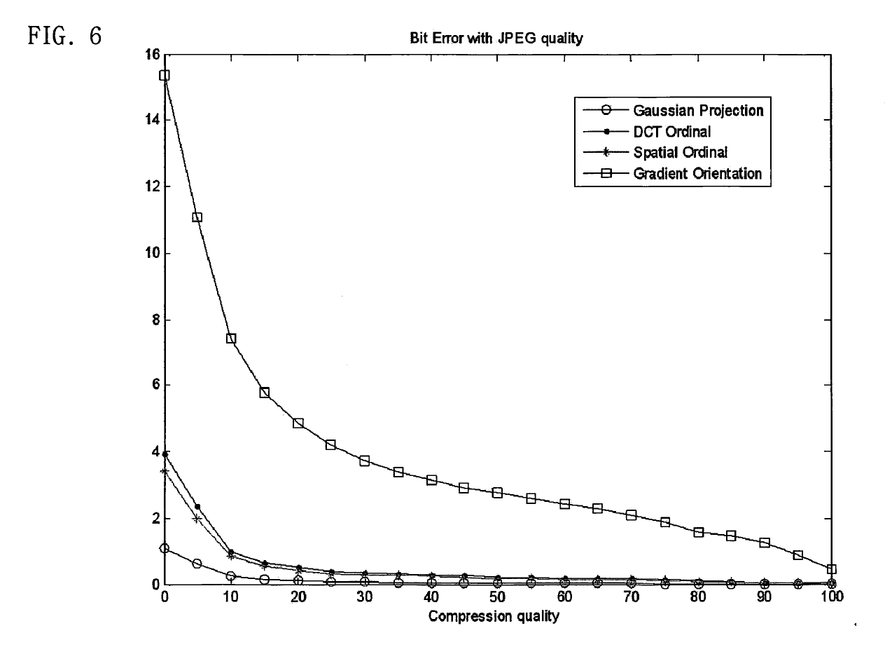

FIGS. 5 and 6 illustrate the results after applying the method of the present invention.

Specifically, FIG. 5 illustrates the plots of normalized average matching scores with respect to the compression ratio when original images and their JPEG compressed images are compared. FIG. 6 illustrates the plots of normalized average matching scores with respect to the noise variance when original images and their corrupted images with Gaussian noise are compared. In FIG. 5, 5000 images of various categories and sizes were used. Hence, the average matching scores are mean values for 5000 images. As indicated by FIGS. 5 and 6, the method of the present invention (labeled “Gaussian Projection”) exhibits the best performance. The method of the present invention makes it possible to recognize an advertisement currently displayed on the TV screen in real time. Based on such matching information, even when the TV screen is used as a monitor of a set-top box, content of a TV broadcast may be recognized in real time and hence supplementary information or advertisement related to the content of the TV broadcast may be provided to the viewer.

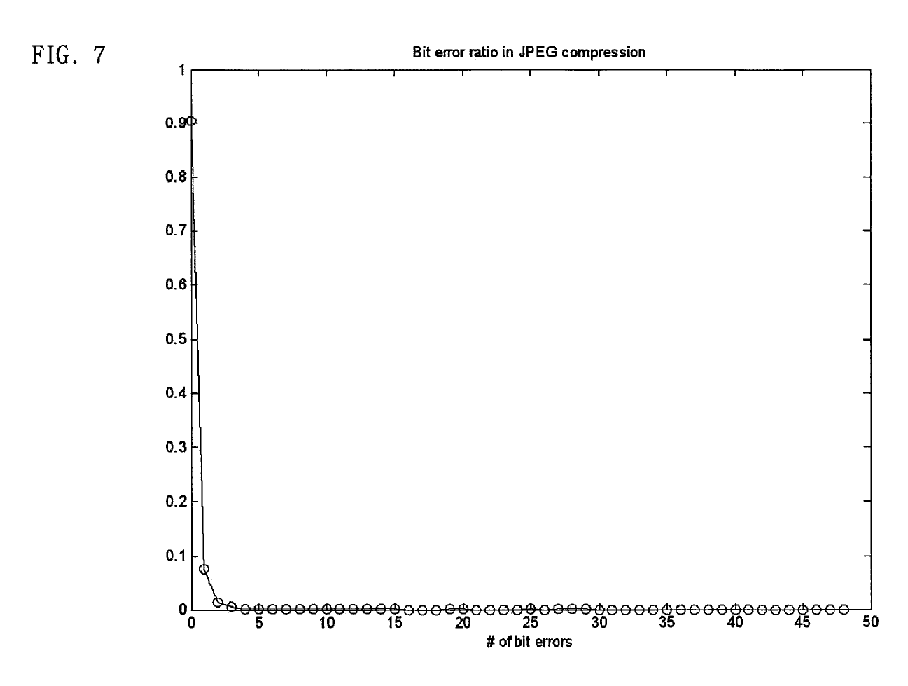

FIG. 7 illustrates a distribution of the bit error rate obtained from applying the JPEG compression and Gaussian noise method of the present invention.

Referring to FIG. 7, the probability of no bit error is about 90.27. The probability of single bit error is about 7.48, and corresponds to 76.88 percent of the overall probability of bit error. As the probability of one bit error takes a major portion of the overall error probability, when single bit errors are permitted, an accuracy level of 97.75 percent is expected. Additionally, in applying the Gaussian noise, the probability of no bit error was about 63.35 and the probability of single bit error was about 25.84. The probability of single bit error corresponds to 70.50 percent of the overall error probability. Hence, when single bit errors are permitted, an accuracy level of 89.19 percent is expected. Since such bit error rates are results of application of incentive image processing operations, significantly lower bit error rates are expected in most image processing applications.

On the basis of the results illustrated above, the fingerprint matcher 140 may search the database using a fingerprint obtained by modifying one bit of the original fingerprint. For example, when the original fingerprint is 48 bits, 48 variant fingerprints may be obtained by modifying one bit of the original fingerprint. Hence, when a search using the original fingerprint fails, the fingerprint matcher 140 may perform an additional search using a variant fingerprint.

Although various embodiments of the present invention have been described in detail herein, many variations and modifications may be made without departing from the spirit and scope of the present invention as defined by the appended claims.

What is claimed is:

1. A method for image processing, comprising:
capturing a frame of an image;
reducing the size of the captured frame;
transforming the reduced frame to a frequency domain frame;
creating an image feature vector by scanning frequency components of the frequency domain frame;
computing inner product values by projecting the image feature vector onto random vectors;
generating a fingerprint for identifying the captured frame by applying a Heaviside step function to the inner product values; and
searching a database for information related to the generated fingerprint and outputting the search results.

2. The method of claim 1, wherein creating an image feature vector comprises scanning low-frequency components of the frequency domain frame except for a Direct Current (DC) component of the frequency domain frame and high-frequency components of the frequency domain frame exceeding a preset threshold value.

3. The method of claim 2, wherein frequency components of the frequency domain frame are scanned in a zigzag fashion during scanning.

4. The method of claim 2, wherein creating an image feature vector further comprises normalizing the image feature vector.

5. The method of claim 1, wherein creating an image feature vector comprises generating multiple random vectors following a Gaussian distribution.

6. The method of claim 1, wherein reducing the size of the captured frame comprises:
selecting a plurality of areas from the captured frame; and
calculating average pixel values for the individual selected areas.

7. The method of claim 6, wherein selecting a plurality of areas comprises selecting multiple areas excluding a predetermined area.

8. The method of claim 7, wherein the predetermined area excluded from selection is an area in which a caption, logo, advertisement or broadcast channel indicator is located.

9. The method of claim 1, wherein reducing the size of the captured frame comprises converting the captured frame into a grayscale frame and reducing the size of the grayscale frame.

10. The method of claim 1, wherein, in transforming the reduced frame, one of Discrete Cosine Transform (DCT), Discrete Fourier Transform (DFT) and Discrete Wavelet Transform (DWT) is applied.

11. The method of claim 1, wherein searching a database for information comprises utilizing a binary search technique to retrieve information related to the fingerprint from the database.

12. The method of claim 1, wherein searching a database for information comprises:
modifying, when no information related to the fingerprint is retrieved, one bit of the fingerprint; and
searching the database for information related to the modified fingerprint.

13. An apparatus for image processing, comprising:
a frame capturer capturing a frame of an image;
a fingerprint extractor extracting a fingerprint from the captured frame; and
a fingerprint matcher searching a database for information related to the fingerprint,
wherein the fingerprint extractor reduces the size of the captured frame, transforms the reduced frame to a frequency domain frame, creates an image feature vector by scanning frequency components of the frequency domain frame, computes inner product values by projecting the image feature vector onto random vectors, and generates the fingerprint by applying a Heaviside step function to the inner product values.

14. The apparatus of claim 13, wherein the fingerprint extractor scans low-frequency components of the frequency domain frame except for a Direct Current (DC) component of the frequency domain frame and high-frequency components of the frequency domain frame exceeding a preset threshold value.

15. The apparatus of claim 13, wherein the fingerprint extractor selects a plurality of areas from the captured frame and calculates average pixel values for the individual selected areas.

16. The apparatus of claim 13, wherein the fingerprint matcher utilizes a binary search technique to retrieve information related to the fingerprint from the database.

17. The apparatus of claim 13, wherein the fingerprint matcher modifies, when no information related to the fingerprint is retrieved, one bit of the fingerprint, and searches the database for information related to the modified fingerprint.
